(19) United States
(12) Patent Application Publication
(10) Pub. No.: US 2004/0033308 A1
(43) Pub. Date: Feb. 19, 2004

(54) Method and device for producing a bitumen-bonded construction material mixture

(75) Inventors: Walter Barthel, Langenselbold (DE); Max Von Devivere, Amersfoort (NL); Jean-Pierre Marchand, Montesson (FR)

Correspondence Address: Ira J. Schultz, DENNISON, SCHULTZ & DOUGHERTY, Suite 612, 1745 Jefferson Davis Highway, Arlington, VA, 22202, US

(73) Assignees: Mitteldeutsche Harstein-Industrie AG; Eurovia Gmbh; Eurovia S.A.

(21) Appl. No.: 10/217,147

(22) Filed: Aug. 13, 2002

(51) Int. Cl. B05D 5/10; B05D 1/02

(52) U.S. Cl. 427/136; 427/421; 366/18

(57) ABSTRACT

The invention relates to a method for producing a bitumen-bonded construction material mixture, such as rolled asphalt, where mineral matter is coated with bitumen that is sprayed onto the mineral matter. So as to have to heat the mineral matter only to a temperature T₁ with 110° C.≦T₁≦160° C., a water-containing additive is mixed in, which is added immediately before and/or during and/or immediately after spraying the binding agent.

The invention relates to a method for producing a bitumen-bonded construction material mixture, especially rolled asphalt. The invention also references a device for producing a bitumen-bonded construction material mixture such as rolled asphalt in particular.

For preparing a hot bituminous mixture out of bitumen or bitumen-containing binding agents and mineral matters, generally temperatures in the range between 150° C. and 250° C. are required. The energy requirement necessary is mainly met with fossil fuels.

It is known that in the production of asphalt mixtures, there is a general tendency towards excessive temperatures. This is due to improved processing characteristics (compression willingness) of the hot asphalt.

Bitumen in the cold state is hard and becomes viscous or liquid with increasing temperatures. The elastic-viscous behavior of the binding agent forms the basis for processing building asphalt of the asphalt building material conditioned therewith. Especially hard bitumen types make high mixing temperatures necessary in order to ensure the coating and thus adhesion of the mineral particles, i.e. the aggregate, in the thin viscous state.

The ability to spread the asphalt and obtaining the necessary degree of compression of traffic surfaces depend upon the pliability of the asphalt mixture so that, as mentioned above, higher mixing temperatures are selected in order to achieve an optimal end product. This necessitates a higher need for energy along with high emission rates into the atmosphere.

For the production of rolled asphalt, mineral substances are initially dried in a drum and then strained, if necessary, whereupon they are stored in chambers. The minerals are then blended, in accordance with the recipe, in a mixer, wherein the mineral substances have a temperature between 160° C. and 200° C. Subsequently, in order to coat the mineral matter, bitumen is added, either through atomization or spraying. The bitumen generally has a temperature between 160°C. and 180° C. as a function of the necessary viscosity. Furthermore, fillers are added, which area admixed before spraying the bitumen, during the spraying process or afterwards. The total time during which the starting products remain in the mixer is about 40 to 60 seconds. Apart from a batch production of rolled asphalt, a continuous production method is also known, wherein basically the same procedural steps are taken.

From EP 0 048 792 B1 a method for producing mastic asphalt is known, which contains 0.2 to 5 percent by weight of a crystalline, powdered, synthetic zeolite or zeolite mixture to increase its stability. The processing temperatures are then reduced from 220° C. without zeolite to 210° C. with 1 percent by weight of zeolite.

The present invention is based on the task of producing a bitumen-bonded construction material mixture, especially rolled asphalt, in a low-energy and low-emission manner without having to allow for losses in the properties of the end product. At the same time, it must be ensured that, for execution of the method, no changes in the conventional production of bitumen-bonded construction material mixtures are required, that no changes have to be made to formulations or suitability examinations of asphalt mixture variations in particular.

Pursuant to the method, the problem is resolved largely with the following procedural steps:

preparation-relevant introduction of mineral matter into a mixing device at a temperature T₁ with 110° C. ≦T₁ ≦160° C.,

spraying of a binding agent on a bitumen basis onto the mineral matter over a duration t₁,

introduction of a water-containing additive into the mixer immediately before and/or during and/or immediately after spraying the binding agent, wherein the additive is sprayed into the mixer over a time period of t₂ with t₂ ≦t₁, or the additive is introduced into the mixer together with a filler while simultaneously mixing it.

Pursuant to the invention, a method for producing bitumen-bonded construction material mixture, especially rolled asphalt, is made available, which compared to familiar production methods is conducted at considerably lower mixture temperatures. This has the benefit that even during the drying process preceding the mixing process, the mineral substances can be processed at lower temperatures and thus in a more energy-friendly manner.

The water-containing additive serves as processing aid in this case, wherein an additive is used that does not release embedded water (water of crystallization) spontaneously, but instead in stages, causing the mixture to remain more pliable over a longer period of time due to the successively released water without making temperature increases and thus increased viscosity changes necessary. Due to the fact that the pliability of the mixture is influenced positively, the construction material mixture exhibits a compression willingness that would generally only be accomplished at higher temperatures. In order to fully exhaust these advantages, it is beneficial if the additive is evenly distributed in the mixture, which should be described as a hot mixture. Pursuant to the invention, this is possible above all through spraying the additive or introducing the additive together with a filler such as rock dust.

The released water brings about a foaming of the binding agent without negatively influencing it so that the mineral matter percentage is coated to the desired extent.

In the processed state, i.e. for example in the case of compacted and cooled-down asphalt surfacing, bituminous mixture that has been removed from the mixer or a mixing system in a continuous process exhibits usage properties that do not differ from conventionally produced asphalt surfacing types.

In particular the invention provides for zeolite or its amorphous synthesis precursor to be used as the additive. The zeolite can be natural and/or synthetic zeolite.

Apart from the generally crystalline zeolites, amorphous substances are also known, which occur e.g. as precursor of the previously mentioned fiber, leaf or cube zeolites. These amorphous compounds already exhibit properties such as ion exchange capability or adsorption ability, which are typical for zeolites. Due to the still very small expansion of the crystalline range, however, no “crystalline” structure can be recognized yet with radiography, so that the zeolite is described as x-ray amorphous. Such substances are also suited for use in the method pursuant to the invention due to their zeolite-like water desorption properties.

Especially fiber zeolites, leaf zeolites or cube zeolites can be used, wherein especially zeolites from the group of the faujasite, chabasite, phillipsite, paulingite or also the clinoptilotite group should be mentioned. Especially A, P, X or Y zeolites are used, wherein such with larger pore width are preferred.

Preferably zeolite powder or granules of type A are used, especially of the formula Na₁₂ (AlO₂)₁₂(SiO₂)₁₂. 27 H_{2 O}, wherein Na₂O contributes 18%, Al₂O₃ 28%, SiO₂ 33% and H₂21%. In particular, a zeolite A powder with the following physical-chemical properties should be used:

| | | |
|---|---|---|
| average particle size | 3.5 | μm |
| density | 2.0 | g/cm³ |
| apparent density | 500 | g/l |
| loss on ignition (1 h/800° C.) | 20% | |
| pH value (5% in water) | 11.6 | |

If zeolite A granules are used, they should exhibit the following physical-chemical properties:

| | | |
|---|---|---|
| average particle size | 380 | μm |
| density | 2.0 | g/cm³ |
| apparent density | 550 ± 50 | g/l |
| loss on ignition (1 h/800° C.) | 19% | |
| pH value (1% in water) | 11 | |

Compared to zeolites gained from natural deposits, synthetically produced zeolites frequently have the advantage of constant homogeneity and quality, an advantage that exists in particular for the required small particle size. Among the synthetic zeolites especially the synthetic zeolite of type A should be emphasized.

Separated from that, an additive with embedded water should be used, the water content of which is between 5 and 30percent by weight, especially 15 to 25 percent by weight.

Bitumen, polymer-modified bitumen or their mixtures in particular come into question as binding agents.

Based on the theory of the invention, there exists the possibility of lowering the mixing temperature of the bitumen-bonded construction material mixture without incurring an undesirable viscosity increase. The bituminous mixture that has been produced has a greater pliability, which enables better spreading.

The benefits obtained with the idea pursuant to the invention can possibly explained with the fact that the addition of water-containing additives to hot bitumen and/or bitumen-containing binding agents leads to a foaming effect due to the transformation in water vapor. This expresses itself in a volume increase, which has a positive effect on the bituminous mixture. The fine-particle water vapor bubbles form micropores, which result in a low gross density of the construction material mixture. In this case it is particularly beneficial that the bituminous mixture experiences considerably better compaction willingness due to the low volume increase. In order to fully exhaust these advantages it is important that a largely even distribution of the water vapor particles in the mixture is given. An even distribution of the water vapor in the bitumen-bonded hot mixture is ensured particularly through zeolite as the water donor. In this case, it is decisive that the H₂O release does not occur spontaneously at the boiling point, but instead occurs continuously. Pursuant to the invention, this takes place by expelling water from the zeolite in the temperature range between 100 and 200° C.

As mentioned above, the occurring micro-bubbles affect a volume increase of the mixture so that it becomes more pliable, without binding agent trickling off or separating. The coating process of the minerals is complete. A detachment of binding agent films of the mineral surface does not occur. After cooling off, a stable building material and/or asphalt coating with good usage properties is obtained.

The binding agent is preferably sprayed during the duration t₁ with 5 s≦t₁ ≦15 s. Spraying of the additive should occur over a period of time of 1 s≦t₂≦5 s. The temperature T₂ of the binding agent should preferably be 160° C. ≦T₂ ≦180°C.

As mentioned before, the additive can be used as powder, granules or in the form of pellets. The additive can be stored in a stationary or mobile silo, from where it is fed into the mixer via a conveying device such as a screw conveyor or under compressed air after being weighed. Pursuant to the invention this occurs parallel to the usual metering processes so that consequently a time delay of the addition and/or mixing phase is eliminated. This in turn means that the introduction of the additive does not lead to a lengthening of the processing intervals so that the mixing performance of an appropriate bituminous building material processing system remains unchanged.

The percentage of the additive is preferably between 0.1 and 5 percent by weight, particularly preferred however between 0.2 and 0.8 percent by weight in relation to the entire mixture.

With the method of the invention, a drop in the mixing temperature by 30° C. to 35° C. can be accomplished, reducing the need for energy by about 30%. Measurements have shown that the specific energy requirement can be lowered by 14 kWh/t asphalt. When considering an asphalt mixing system that during normal operation requires 8 liters fuel oil/t asphalt, this means a savings of 2.4 liters. Assuming that, in the Federal Republic of Germany, the annual production of asphalt is about 65 million tons, this means savings of 400,000 tons of carbon dioxide.

Furthermore it should be pointed out that a lower temperature bituminous construction material mixture creates fewer aerosols and vapors. Measurements were also able to prove the reduction of emissions. A lower pollutant and odor percentage was also detectable. Measurements with mixing experiments have shown that in the case of using standard bitumen B65 at 168° C., 350.7 mg of vapors and aerosols per m³ air arose, and at a temperature of 142° C., only 90.4 mg per m³ of air occurred due to the additive in the form of zeolite. A lowering of the mixing temperature by 26° C. thus resulted in a reduction of ultra-fine particles by 74%.

Considerable changes are also experienced with the odor. Evaluations with subjects resulted in a lower number of odor units (GE) in the case of a construction material mixture that was produced at a lower temperature pursuant to the idea of the invention compared to asphalt of normal temperatures. With regard to the spreading behavior, no disadvantages could be detected compared to regular asphalt material. The desired surface structures were also achieved without difficulty.

Changes with regard to usage properties, stability, gripping capacity, weather resistance and durability were not noticed in the production of rolled asphalt.

The bituminous construction material mixture that was produced pursuant to the invented method consequently exhibits the same properties as the material produced at higher temperatures.

A device for producing bitumen-bonded construction material mixtures, especially rolled asphalt, comprising a mixer that mixes mineral matter, binding agent and possibly filler, is distinguished by the fact that the device is assigned a silo, in which a water-containing additive is stored, that a weighing device for the metered feeding of the additive into the mixer is located after the silo and that the weighing device is connected with the mixer via a conveyor. In this case, the conveying device can be a conveyor such as a screw conveyor for the filler that is to be fed to the mixer. The conveying device can also be a pneumatic conveyor, which leads to the spraying device present in the mixer, such as a nozzle.

In the case of a mobile silo, it should have standard dimensions so that it can be transported on a truck.

For the purpose of removing the additive from the silo, a cell wheel lock is provided, from which the additive is supplied to the weighing device. So as to make a mobile device available that is easy to handle, it is furthermore suggested to arrange control, weighing and conveying devices for a truck that can be aligned with the silo.

In summary it can be said that with regard to the mineral substances composition, type and quantity of binding agent, time sequence of the mixing process and mixing performance a bituminous construction material mixture produced with the method of the invention, especially rolled asphalt, corresponds to a bituminous construction material mixture that has been produced pursuant to the state of the art at higher temperatures.

Introducing the additives and their separate weighing process itself requires no change in the batch mixing times so that the production output remains the same as that of conventional systems. The same applies for the case that instead of a batch operation a continuous operation is performed.

By lowering the bituminous mixture temperature by more than 30° C., lower specific energy requirements are necessary. The resulting energy savings lead to lower CO₂ emissions into the atmosphere and to reduced pollutant and odor percentages, owing to which a protection of the environment takes place. Due to the fact that the process takes place at lower temperatures, a reduction in the wear of the parts of the apparatus can be achieved. The lowering of the temperature of the binding agent due to the reduced temperatures of the mineral substances leads to reduced oxidation values and thus a curbed aging of the binding agent with the consequence that a longer life of asphalt fortifications is attainable.

Further details, benefits and features of the invention result not only from the claims and the features revealed in them—either alone and/or in combination—but also from the following description of preferred embodiments shown in the drawing.

Shown are:

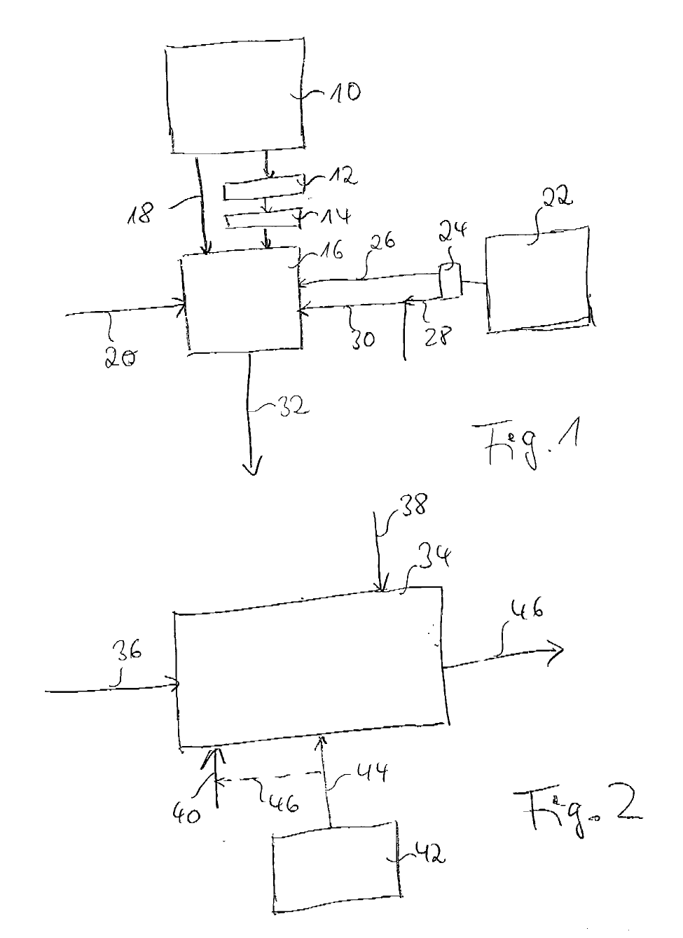

FIG. 1 a first flow chart for the production of a bitumen-bonded construction material mixture,

FIG. 2 a second flow chart for the production of a bitumen-bonded construction material mixture,

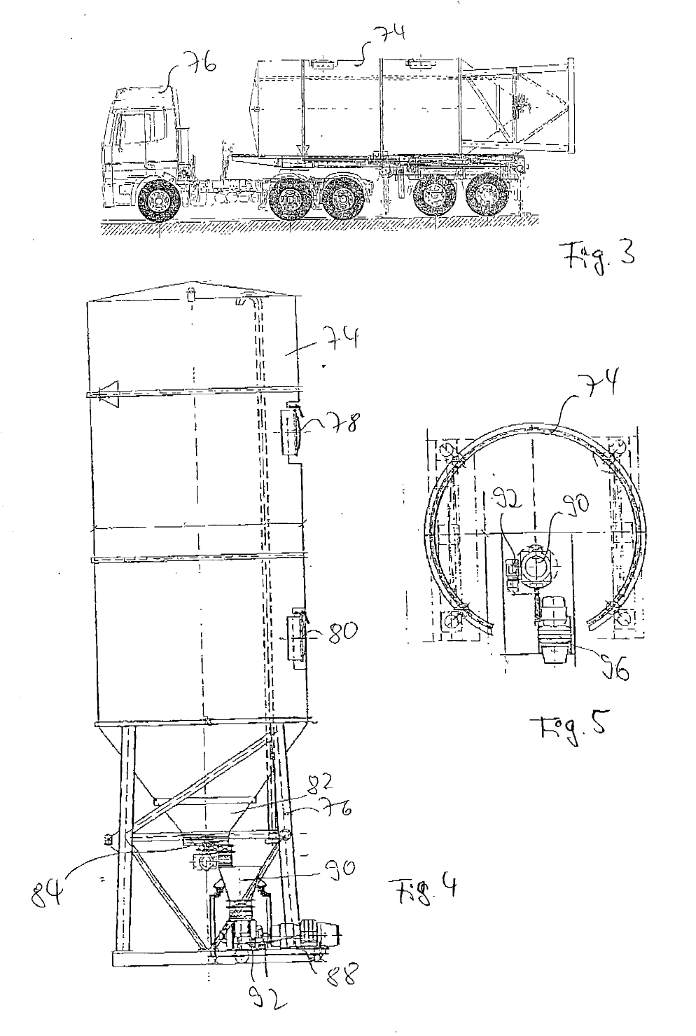

FIG. 3 a silo transported on a truck,

FIG. 4 the silo pursuant to FIG. 3 in the operating state,

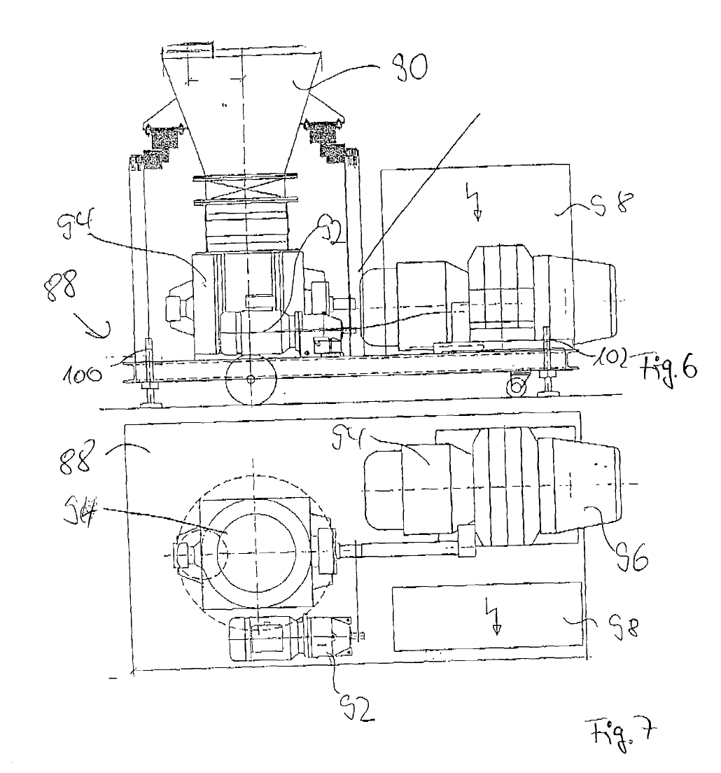

FIG. 5 a top view onto the silo pursuant to FIG. 4,

FIG. 6 a basic diagram of a cart with weighing and conveying devices,

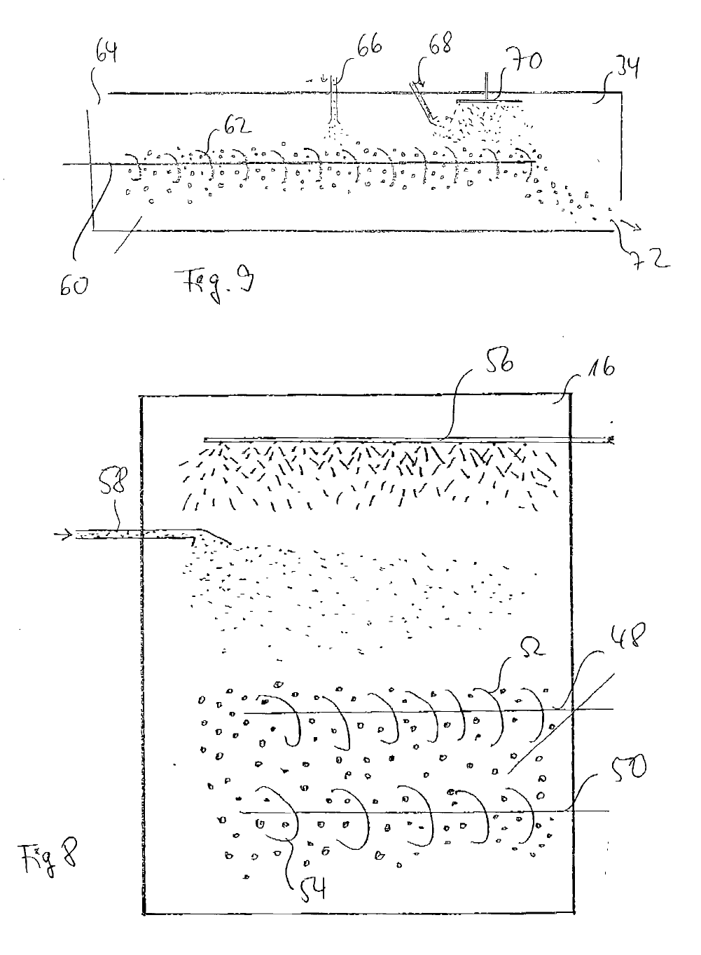

FIG. 7 the cart pursuant to FIG. 6 in a top view,

FIG. 8 a basic diagram of a mixer for producing a bitumen-bonded construction material mixture, and

FIG. 9 a second embodiment of a mixer.

FIGS. 1 and 2 reveal two flow charts for a basic explanation of production methods of bitumen-bonded construction material mixtures, especially rolled asphalt. FIG. 1 shows a batch production method, and FIG. 2 a continuous method.

Pursuant to the embodiment of FIG. 1, mineral matter is initially dried in a drum 10, then strained, if necessary (procedural step 12), and subsequently separated by grain size and stored (procedural step 14). In accordance with the bitumen-bonded construction material mixture that is to be prepared, mineral matter is then added into a mixer 16. Alternatively mineral matter can be fed to the mixer 16 directly after the drum 10 (arrow 18).

In the mixer 16, in which the mineral matter has a temperature in the range of 110° C. to 160° C., bitumen is then sprayed or atomized (arrow 20). Furthermore, a water-containing additive such as especially synthetic zeolite, which has been removed from a silo 22 via a weighing device 24, is sprayed or atomized in the mixer 16 (26), or the additive is metered in together with a filler such as rock dust (arrows 28, 30). These measures allow the bitumen-bonded construction material mixture to be produced at considerably lower temperatures compared to conventional methods. Considerably lower in this case means in the range of at least 30° C. below the temperature that is generally applied. After an overall duration of about 40 to 60 seconds, during which the mineral matter has been mixed with the bitumen, the additive and the filler in the mixer 16, the bitumen-bonded construction material mixture is pulled from the mixer 16 (arrow 32), and the mixer 16 is filled again in the above-described manner.

FIG. 2 depicts the basic principle of a continuous method. In this case, the dryer 10 and the mixer 16 from FIG. 1 form a unit e.g. in the form of a drying drum 34, into which the mineral substances are introduced on one end (arrow 36) in order to be dried in the drying drum 34 on the one hand, and on the other hand to be coated with bitumen in the above-described manner. The bitumen is added after the necessary drying process for the mineral matter e.g. in a spraying or atomizing process (arrow 38). Preferably before that a filler (arrow 40) as well as a water-containing additive (arrow 44) that has been weighed and removed from a silo 42 are added, whereby alternatively the additive can be supplied together with the filler via e.g. a screw conveyor of the drying drum 34 while the filler and the additive are mixed during the addition process. This joint introduction is indicated basically with the dotted arrow 46. After coating the mineral matter with the bitumen, the finished bitumen-bonded construction material mixture is removed from the drying drum 34 (arrow 48). The method described here is performed continuously.

The above-described method or mixer 16 or drying drum 34 that is employed is explained again on the basis of FIG. 8 and 9. FIG. 8 reproduces a basic diagram of a mixer 16, which in its lower area contains forced action mixing elements 48, 50 with rotating arms 52, 54 for swirling the supplied mineral matter. Above the forced action mixing elements 48, 50 a nozzle configuration 56 is arranged for spraying or atomizing bitumen in order to coat the mineral matter that is swirled by the forced action mixing elements 48, 50 with bitumen. In order to be able to perform this mixing process at relatively low temperatures, a water-containing additive preferably in the form of synthetic zeolite is supplied additionally via a feeding device 58, which can also be a nozzle configuration. Together with the additive or separate from it, a filler such as rock dust can also be introduced. As shown in FIG. 1, batch production of a bitumen-bonded construction material mixture takes place in mixer 16.

FIG. 9 is meant to clarify the continuous method corresponding to FIG. 2. A mixing element 60, which likewise assume the form of a forced action mixing element with downwardly rotating arms 62, extends in the drying drum 34 largely across its length in order to swirl the mineral matter that has been fed at the beginning of the drying drum 34 via an opening 64 and dry it initially to the necessary extent. The mineral substances are heated to about 110° C. to 160° C. during this process.

At a distance to the opening 64, a filler is introduced via a feeding device 66. At a distance thereto and consequently delayed in time, the water-containing additive is introduced via an additional feeding device 68 in order to be able to produce the desired bitumen-bonded construction material mixture at relatively low temperatures. After that, bitumen is sprayed or atomized via an atomizing device 70 in order to coat the mineral matter with bitumen to the necessary extent. Finally, the finished bitumen-bonded construction material mixture is removed via an outlet port 72.

So as to be able to meter the necessary quantity of the additive—the additive is introduced preferably at a quantity of 0.1 to 5 percent by weight, especially 0.2 to 0.8 percent by weight of the mixture consisting of mineral matter, bitumen and filler—a silo 74 is provided, the dimensions of which are such that it can be transported on a truck 76. The silo 74 is equipped with a support frame 76. Apart from filling ports 78, 80, which are arranged on the side of a silo 74, as well as filling and ventilation lines, which are not described in detail, in order to offer ventilation to the silo 74, it is also equipped with a vibrator console with a vibrator 82 in order to ensure a desired flow behavior of the additive in the silo 74.

In order to meter the additive in the necessary quantity and feed it to the mixer 10 or the drying drum 34, a cart 88 with a wheel metering device 90 is aligned with the opening 84 of the silo 74. The cell wheel metering device 90 can be actuated via an electric motor 92. The additive is then weighed in a weighing device. Subsequently the metered additive is fed to a pressurized feeding container 94. Compressed air, with which the additive is fed to the mixer 16 or the drying drum 34, is created with a rotary compressor 96.

Alternatively the additive can be placed on a screw conveyor, via which the filler is added to the mixer 16 or the drying drum 34.

The cart 88 furthermore contains a control cabinet 98. In order to be able to align the cart 88 with the horizontal, spindles 100, 102 are available.

While the additive is preferably supplied in powder form, additive granules or additive pellets are also possible.

There is also the possibility to store and transport the additive in so-called disposable bags. The additive can then be filled from the bags into a metering container, from where it is processed further, wherein the possibility of above-described methods exists. Appropriate bags generally consist of polymer-coated tissue, wherein the seams are additionally sealed. On the bottom of these bags or containers outlet hoses of e.g. 35 cm diameter are arranged. The outlet hoses are closed with a closure element such as a string-wedge clamp, which can be opened by the operator without risk even under suspended load. The bags can be delivered on pallets with a size of 110 cm ×110 cm. 2 m³ bags contain 700 to 800 kg additive such as zeolite. Bags of the size 1.1 m³ can be filled with 100 to 500 kg.

1. Method for producing a bitumen-bonded construction material mixture, in particular rolled asphalt, comprising the following procedural steps:
preparation-relevant introduction of mineral matter into a mixing device at a temperature T₁ with 110° C.≦T₁≦160° C.,
spraying of a binding agent on bitumen basis with a temperature T₂ onto the mineral matter over a duration t₁,
introduction of a water-containing additive into the mixer immediately before and/or during and/or immediately after spraying the binding agent, wherein the additive is either sprayed into the mixer over a time period of t₂ with T₂≦t₁ or the additive is introduced into the mixer together with a filler while simultaneously mixing it.

2. Method according to claim 1, characterized in that zeolite or its amorphous synthesis precursor is used as the additive.

3. Method according to claim 2, characterized in that natural and/or synthetic zeolite is used as the additive.

4. Method according to claim 3, characterized in that fiber zeolite, leaf zeolite and/or cube zeolite is used as the zeolite.

5. Method according to claim 3, characterized in that zeolite from the group of the faujasite, chabasite, phillipsite, clinoptilosite and/or paulingite is used as the zeolite.

6. Method according to claim 3, characterized in that synthetic zeolite of the type A and/or P and/or X and/or Y is used as the zeolite.

7. Method according to claim 3, characterized in that zeolite is used in powder or granule form or in the form of pellets.

8. Method according to claim 2, characterized in that zeolite A granulate with the properties

| | | |
|---|---|---|
| average particle size | 380 | μm |
| density | 2.0 | g/cm³ |
| apparent density | 550 ± 50 | g/l |
| loss on ignition (1 h/800° C.) | 19% | |
| pH value (1% in water) | 11 | |

is used.

9. Method according to claim 2, characterized in that zeolite A powder with the properties

| | | |
|---|---|---|
| average particle size | 3.5 | μm |
| density | 2.0 | g/cm³ |
| apparent density | 500 | g/l |
| loss on ignition (1 h/800° C.) | 20% | |
| pH value (5% in water) | 11.6 | |

is used.

10. Method according to claim 1, characterized in that rock dust is used as a filler.

11. Method according to claim 1, characterized in that bitumen, polymer-modified bitumen or their mixtures are used as binding agents.

12. Method according to claim 1, characterized in that an additive is used the water content of which is 5 to 30 percent by weight, particularly 15 to 25 percent by weight.

13. Method according to claim 1, characterized in that the additive is fed to the mixture of mineral matter, bitumen and filler at a quantity of 0.1 to 5 percent by weight, especially 0.2 to 0.8 percent by weight.

14. Method according to claim 1, characterized in that the binding agent is sprayed at a temperature T₂ with 160° C.≦T₂≦180° C.

15. Method according to claim 1, characterized in that the binding agent is sprayed during the time t, with 5 s≦t₁≦15 s.

16. Method according to claim 1, characterized in that the additive is sprayed over a period of time t₂ of 1 s≦t₂≦5 s.

17. Device for conducting the method according to at least claim 1, comprising a mixing device that mixes mineral matter, binding agent and possibly fillers, characterized in that the water-containing additive is stored in a silo (74), in that outlets (84) of the silo are connected with a weighing device and in that the weighing device is connected with the mixing device (16, 34) via a conveying device.

18. Device according to claim 17, characterized in that the conveying device is a conveyor for the filler that is supposed to be supplied to the mixing device (16, 34).

19. Device according to claim 17, characterized in that the conveying device is a pneumatic conveyor, which leads to a spraying device (58, 68) present in the mixing device (16, 34).

20. Device according to claim 17, characterized in that the silo (74) has a mobile or stationary design.

21. Device according to claim 20, characterized in that the mobile silo (74) is dimensioned such that it can be transported on a truck (76).

22. Device according to claim 17, characterized in that the additive can be supplied via a cell wheel lock (9) and a weighing device that is arranged after this in series.

23. Device according to claim 17, characterized in that a control device (98), a weighing device as well as a conveying device (96) are arranged on a cart (88) that can be aligned with the silo (74).

24. Device according to claim 23, characterized in that the conveying device (96) comprises a rotary compressor (96) in front of which a pressurized conveying container (94) is arranged.
